(19) United States
(12) Patent Application Publication
(10) Pub. No.: US 2008/0233321 A1
(43) Pub. Date: Sep. 25, 2008

(54) Inflatable structure

(75) Inventor: Chiang-Chuan Lin, Dayuan Shiang (TW)

Correspondence Address: BIRCH STEWART KOLASCH & BIRCH, PO BOX 747, FALLS CHURCH, VA, 22040-0747, US

(73) Assignees: Chiang-Chuan LIU; Szu-Yuan LIU; TECHARME APPAREL CO., LTD.

(21) Appl. No.: 11/723,681

(22) Filed: Mar. 21, 2007

(51) Int. Cl. B32B 1/08

(52) U.S. Cl. 428/36.1; 428/35.7

(57) ABSTRACT

An inflatable structure includes a hollow fabric body having three hydrophilic and vapor-transmissible plastic layers sequentially applied over an inner surface thereof, and including at least one continuous S-shaped bonding line, along which areas on an outer surface of the hollow fabric body at two opposite sides thereof are bonded together. The three hydrophilic and vapor transmissible plastic layers are lightweight, waterproof, vapor transmissible, and warm; and the S-shaped bonding line has small width to allow increased inflatable space in the hollow fabric body. The continuous S-shaped bonding line has two ends formed into two closed circular bonding lines to avoid damage of the inflatable structure by stress concentrated at the bonding line.

### FIELD OF THE INVENTION

The present invention relates to an inflatable structure, and more particularly to an inflatable structure that includes a hollow fabric body having three hydrophilic and vapor-transmissible plastic layers sequentially applied over an inner surface thereof, and including at least one continuous S-shaped bonding line, along which areas on an outer surface of the hollow fabric body at two opposite sides thereof are bonded together.

### BACKGROUND OF THE INVENTION

People wear warm clothes, such as a down coat, to protect themselves against cold in winter. The down coat is insulated with loose down, in which air is held to isolate external cold from a wearer's skin. However, when the down is compressed by an external force to expel the air held therein, it becomes less effective in warm keeping. Moreover, since the down is the first soft feathers of birds, it inevitably has the potential problems of bad odor and Avian Influenza. And, some people might be allergic to down.

Some inflatable structures, such as inflatable garments, have been developed to replace the down coat. An inflatable garment usually has inner and outer sides partially bonded together by various bonding manners to form a closed inflatable space in the inflatable garment. Depending on a wearer's need or preference in warm keeping, an adequate amount of air may be conveniently supplied into or released from the inflatable space to isolate external cold air from the wearer's body.

The conventional inflatable structures usually include different plastic materials, which may be generally divided into three types. The first type is PVC (Polyvinyl chloride) material, which has relatively weak bonding strength and therefore requires a minimum thickness of 0.15 to 0.20 mm to ensure a satisfied bonding strength. With the required large thickness, the conventional inflatable structure made with the PVC material is quite heavy. The PVC material also has the disadvantages of being non-breathable and producing dioxin after being burned to become environmentally hazardous. Therefore, the inflatable structure with PVC material has gradually lost its share in the market. The second type is TPU (thermoplastic polyurethane) material, which is thick, heavy, non-vapor-transmissible, and stiff in touch, and requires high processing cost. The third type is a breathable TPU material, which has relatively weak bonding strength and low air-holding ability, and requires extremely high processing cost while the bad yield thereof is very high.

The conventional inflatable structures also have problems with the bonding thereof. FIG. 1 shows a first conventional inflatable structure 1 configured as an inflatable coat. As shown, the inflatable structure 1 must have a plurality of relatively wide straight bonding strips 11 because of the weak bonding strength of the plastic material thereof. Warm air surrounding the wearer's body tends to leak via the wide bonding strips 11, and external cold air may easily invade the inflatable structure 1 via the wide bonding strips 11 to degrade the warm keeping property of the inflatable structure 1. Moreover, stress tends to concentrate at two ends of the straight bonding strips 11 on the conventional inflatable structure 1 to cause damage at the two ends and leakage of air thereat when the inflatable structure 1 is subjected to a relatively large compression.

FIG. 2 shows a second conventional inflatable structure 2 configured as an inflatable coat, too. The inflatable structure 2 includes a plurality of circular bonding areas 21 to solve the problem of stress concentration. However, due to the weak bonding strength of the plastic material of the inflatable structure 2, the circular bonding areas 21 must have a relatively large diameter. Again, warm air surrounding the wearer's body tends to leak via the large circular bonding areas 21, and external cold air may easily invade the inflatable structure 2 via the large circular bonding areas 11 to degrade the warm keeping property of the inflatable structure 2. Moreover, the large circular bonding areas 21 inevitably decreases the air volume that can be held in the inflatable structure 2 to further reduce the warm keeping effect of the inflatable structure 2.

It is therefore tried by the inventor to develop an improved inflatable structure that is lightweight, waterproof, vapor-transmissible, durable, and warm.

### SUMMARY OF THE INVENTION

A primary object of the present invention is to provide an inflatable structure that is lightweight, waterproof, and vapor transmissible, and has strengthened bonding line to ensure increased and durable inflatable space, and is therefore suitable for making different lightweight, waterproof, vapor-transmissible, and warm-keeping articles.

To achieve the above and other objects, the inflatable structure according to the present invention includes a hollow fabric body having an inner surface and an outer surface; a solvent-based hydrophilic and vapor-transmissible plastic layer applied to the inner surface of the hollow fabric body; a low-modulus hydrophilic and vapor-transmissible plastic layer provided over the solvent-based hydrophilic and vapor-transmissible plastic layer; a low-melting-point hydrophilic and vapor-transmissible plastic layer provided over the low-modulus hydrophilic and vapor-transmissible plastic layer to enclose an inflatable space therein; at least one continuous S-shaped bonding line, along which areas on the outer surface at two opposite sides of the hollow fabric body are bonded together to limit an inflated overall thickness of the hollow fabric body, and the S-shaped bonding line being formed at two ends with a closed circular bonding line each; and an inflating valve provided on the hollow fabric body to communicate with the inflatable space, so that air may be supplied into or released from the inflatable space via the inflating valve. With the above arrangements, the inflatable structure of the present invention is suitable for making different lightweight, waterproof, vapor-transmissible, durable, and warm garments.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a first conventional inflatable structure configured as an inflatable coat;

FIG. 2 is a perspective view of a second conventional inflatable structure configured as an inflatable coat;

FIG. 3 is a perspective view of an inflatable structure according to a preferred embodiment of the present invention;

FIG. 4 is an enlarged sectional view taken along line 4-4 of FIG. 3;

FIG. 5 is a perspective view showing some applications of the inflatable structure of the present invention;

FIG. 6 is a perspective view showing another application of the inflatable structure of the present invention; and

FIG. 7 is a perspective view showing a further application of the inflatable structure of the present invention.

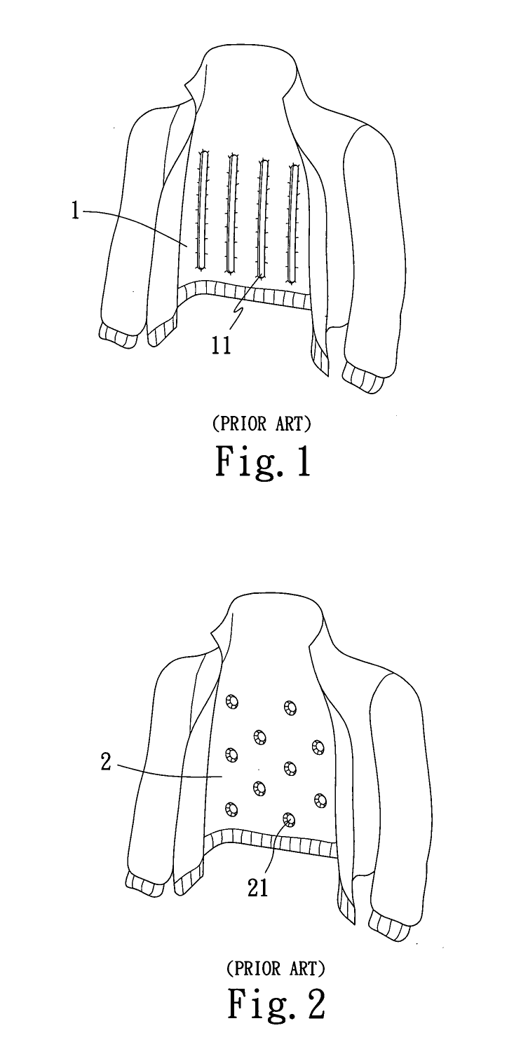

### DETAILED DESCRIPTION OF THE PREFERRED EMBODIMENTS

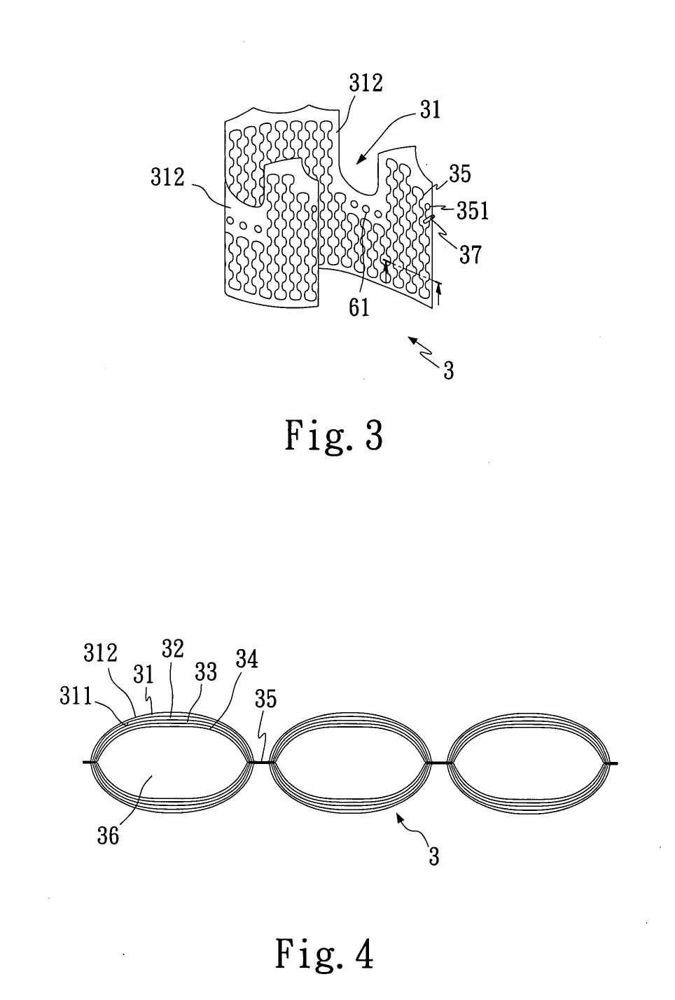

Please refer to FIG. 3 that is a perspective view of an inflatable structure 3 according to a preferred embodiment of the present invention, and to FIG. 4 that is an enlarged sectional view taken along line 4-4 of FIG. 3.

As shown, the inflatable structure 3 includes a hollow fabric body 31 having an inner surface 311 and an outer surface 312, and may be made of a material selected from the group consisting of Nylon, Nylon 66, and Tetoron (polyester fiber); a solvent-based hydrophilic and vapor-transmissible plastic layer 32 applied over the inner surface 311 of the hollow fabric body 31 and having a high permeability to increase a bonding strength between the solvent-based hydrophilic and vapor-transmissible plastic layer 32 and the inner surface 311 of the hollow fabric body 31; a low-modulus hydrophilic and vapor-transmissible plastic layer 33 provided over the solvent-based hydrophilic and vapor-transmissible plastic layer 32 to give the hollow fabric body 31 a soft and rich touch; a low-melting-point hydrophilic and vapor-transmissible plastic layer 34 provided over the low-modulus hydrophilic and vapor-transmissible plastic layer 33 to enclose an inflatable space 36 therein; at least one continuous S-shaped bonding line 35; and an inflating valve 37.

The low-melting-point hydrophilic and vapor-transmissible plastic layer 34 has a low melting point, and can therefore be easily processed to provide enhanced bonding strength at a bonded area. The three hydrophilic vapor-transmissible plastic layers 32, 33, and 34 have a total thickness ranged from 0.03 mm to 0.05 mm. Preferably, the three hydrophilic vapor-transmissible plastic layers 32, 33, and 34 have a total thickness of 0.05 mm. Due to the small thickness, the three plastic layers 32, 33, 34 together have a relatively low weight of about 60-70 g/m².

The continuous S-shaped bonding line 35 has two ends formed into a closed circular bonding line 351 each, and is formed by high-frequency sealing, supersonic welding, or heat bonding, so that areas on the outer surface 312 at two opposite sides of the hollow fabric body 31 is bonded along the S-shaped bonding line 35 to limit an inflated overall thickness of the hollow fabric body 31. The S-shaped bonding line 35 is preferably formed by high-frequency sealing to achieve a bonding strength up to 150N/5 cm. The closed circular bonding lines 351 formed at two ends of the S-shaped bonding line 35 facilitate uniform stress distribution. That is, with the two closed circular bonding lines 351, stress would not concentrate at a certain particular position to cause damage of the inflatable structure 3 of the present invention when the same is subjected to a relatively large compression. Moreover, the S-shaped bonding line 35 has a width which is ranged from 1 to 2 mm, and is preferably 2 mm. Since the width of the S-shaped bonding line 35 is small, the overall volume of the inflatable space 36 is advantageously increased to thereby upgrade the warm keeping effect of the inflatable structure 3.

The inflating valve 37 is provided on the hollow fabric body 31 to communicate with the inflatable space 36. An adequate amount of air may be supplied into or released from the inflatable space 36 via the inflating valve 37 according to the user's personal need for keeping warm.

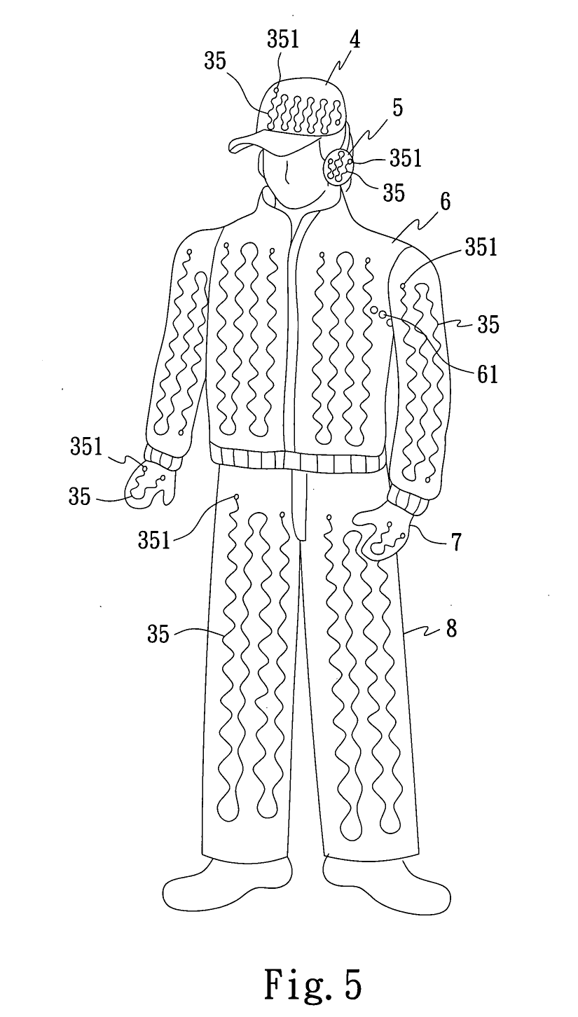

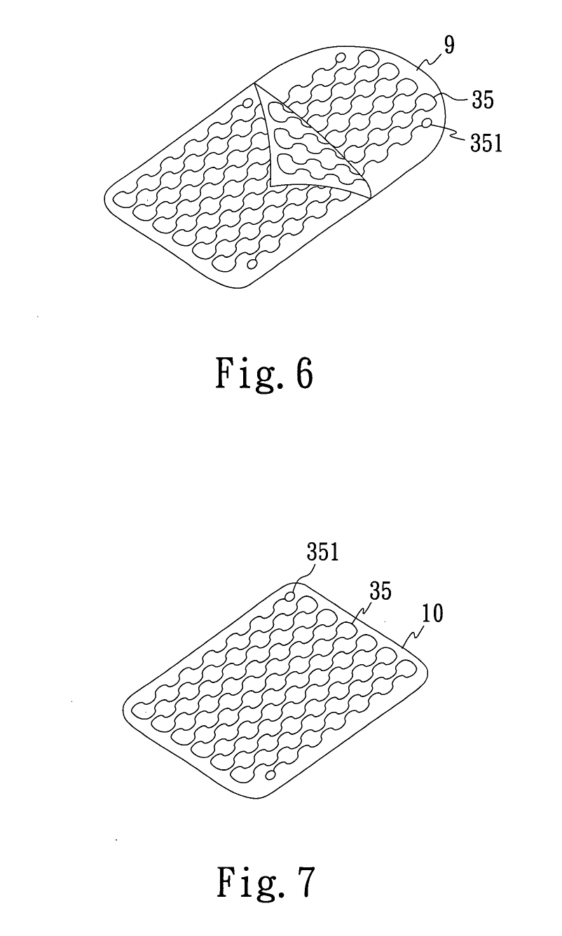

The inflatable structure 3 of the present invention may be used to produce different things, such as, for example, an inflatable hat 4, inflatable earmuffs 5, an inflatable coat 6, inflatable gloves 7, and inflatable trousers 8 as shown in FIG. 5, an inflatable sleeping bag 9 as shown in FIG. 6, and an inflatable quilt 10 as shown in FIG. 7. Taking the inflatable coat 6 made of the inflatable structure 3 of the present invention as an example, since moisture from a wearer's body is allowed to pass through the hollow fabric body 31 and be absorbed by the solvent-based hydrophilic and vapor-transmissible plastic layer 32, and with a water delivery movement existing between the low-modulus hydrophilic and vapor-transmissible plastic layer 33 and the low-melting-point hydrophilic and vapor-transmissible plastic layer 34, moisture absorbed by the solvent-based hydrophilic and vapor-transmissible plastic layer 32 is finally delivered to the external atmosphere. Therefore, the wearer would not feel sweltering while warm air surrounding the wearer's body is kept inside the inflatable coat 6. On the other hand, external cold wind and rainwater are isolated from the wearer's body by the inflatable coat 6 without the risk of penetrating through the three plastic layers 32, 33, and 34. Therefore, the inflatable coat 6 is windproof, waterproof, vapor transmissible, durable, and warm. The inflatable coat 6 may be provided at positions near two armpits with three vents 61 each, so as to facilitate evaporating of sweat at the armpits.

The inflatable structure 3 of the present invention utilizes the solvent-based hydrophilic and vapor-transmissible plastic layer 32, which may be bonded via high-frequency sealing to provide an increased bonding strength of up to 150N/5 cm, and can therefore extend the usable life of the inflatable structure. Further, the three hydrophilic plastic layers 32, 33, and 34 provide a high vapor transmissibility of more than 5000 g/m² and a high water resistance of more than 10000M/M, and have an overall thickness less than 0.05 mm and a low weight of 60-70 g/m². The three plastic layers 32, 33, 34 also provide soft touch, making the inflatable structure 3 of the present invention a fabric comfortable for use. The three plastic layers 32, 33, 34 may be applied over the hollow fabric body 31 by any conventionally known way at low processing cost. Moreover, the continuous S-shaped bonding line 35 with two closed circular bonding lines 351 formed at two ends thereof uniformly distributes any stress thereof without causing concentrated stress at a certain particularly position, and is not easily damaged when the inflatable structure 3 is subjected to a relatively large compression. The small width of less than 2 mm of the S-shaped bonding line 35 allows an increased inflatable space 36 in the hollow fabric body 31 and accordingly, upgraded warm-keeping effect.

In brief, the inflatable structure 3 of the present invention includes a hollow fabric body 31 that has three hydrophilic and vapor transmissible plastic layers applied thereon, and is bonded together at two opposite sides along at least one narrow but strong continuous S-shaped bonding line 35 with two closed circular bonding lines 351 formed at two ends thereof, so that the hollow fabric body 31 is light in weight, durable for use, waterproof, and vapor-transmissible, and provides the largest possible inflatable space to enable good warm keeping effect, making the inflatable structure 3 of the present invention industrial valuable and practical for use to meet the market demands.

What is claimed is:

1. An inflatable structure, comprising:
a hollow fabric body having an inner surface and an outer surface;
a solvent-based hydrophilic and vapor-transmissible plastic layer applied over the inner surface of the hollow fabric body;
a low-modulus hydrophilic and vapor-transmissible plastic layer provided over the solvent-based hydrophilic and vapor-transmissible plastic layer;
a low-melting-point hydrophilic and vapor-transmissible plastic layer provided over the low-modulus hydrophilic and vapor-transmissible plastic layer to enclose an inflatable space therein;
at least one continuous S-shaped bonding line, along which areas on the outer surface at two opposite sides of the hollow fabric body are bonded together to limit an inflated overall thickness of the hollow fabric body, and the S-shaped bonding line being formed at two ends with a closed circular bonding line each; and
an inflating valve provided on the hollow fabric body to communicate with the inflatable space, so that air is supplied into or released from the inflatable space via the inflating valve;
whereby the inflatable structure is suitable for making different warm-keeping articles.

2. The inflatable structure as claimed in claim 1, wherein the hollow fabric body is made of a material selected from the group consisting of Nylon, Nylon 66, and Tetoron.

3. The inflatable structure as claimed in claim 1, wherein the solvent-based, the low-modulus, and the low-melting-point hydrophilic and vapor-transmissible plastic layer have a total thickness ranged from 0.03 mm to 0.05 mm.

4. The inflatable structure as claimed in claim 3, wherein the solvent-based, the low-modulus, and the low-melting-point hydrophilic and vapor-transmissible plastic layer have a total thickness of 0.05 mm.

5. The inflatable structure as claimed in claim 1, wherein the continuous S-shaped bonding line is formed in a manner selected from the group consisting of high-frequency sealing, supersonic welding, and heat bonding.

6. The inflatable structure as claimed in claim 5, wherein the continuous S-shaped bonding line is formed by high-frequency sealing.

7. The inflatable structure as claimed in claim 1, wherein the continuous S-shaped bonding line has a width ranged from 1 mm to 2 mm.

8. The inflatable structure as claimed in claim 7, wherein the continuous S-shaped bonding line has a width of 2 mm.

9. The inflatable structure as claimed in claim 1, wherein the warm-keeping articles are selected from the group consisting of inflatable hats, inflatable earmuffs, inflatable coats, inflatable gloves, inflatable trousers, inflatable sleeping bags, and inflatable quilts.

10. The inflatable structure as claimed in claim 9, wherein the inflatable coats are provided at a position near each armpit with at least one vent.
